(19) United States
(12) Patent Application Publication
(10) Pub. No.: US 2012/0206331 A1
(43) Pub. Date: Aug. 16, 2012

(54) Methods and Systems for Supporting Gesture Recognition Applications across Devices

(76) Inventor: Sidhant D. Gandhi, Fremont, CA (US)

(21) Appl. No.: 13/026,598

(22) Filed: Feb. 14, 2011

(51) Int. Cl. G06F 3/01; G06F 9/44

(52) U.S. Cl. 345/156; 717/100; 719/328

(57) ABSTRACT

Embodiments herein disclose methods and systems for supporting gesture recognition capable applications to be supported across gesture recognition capable devices. Further disclosed are the marketplace, and network mechanisms to deliver applications and advertisements to multiple devices. A middleware is provided for a gesture recognition device that will provide the common API for a gesture recognition capable application. The same application may be used or played on any other device hosting the supported middleware specific to the device. Developers of applications are provided with a single SDK. The middleware also hosts a network application that will enable a user to search and download supported applications, provide feedback to the network, and provide configuration capabilities.

### TECHNICAL FIELD

The embodiments herein relate to gesture recognition and, more particularly, to methods and systems for supporting gesture recognition applications across devices.

### BACKGROUND

Gesture recognition technology enables systems to detect gestures made by a user and perform actions corresponding to the captured gestures. In gesture recognition enabled systems, user performs certain pre defined gestures corresponding to the action he/she need to perform on the display device. A gesture recognition capable system captures the gesture and determines the action to be performed.

Gesture recognition technology may be enabled in a host of devices. Examples of such devices include TV, game consoles, set top boxes and so on. Various companies are trying to come up with interesting apps that are gesture recognition enabled. Most notable applications of gesture recognition are the gaming applications that come with gaming consoles like WII or XBOX. There are also other players trying to attract customers with gesture recognition technology enabled devices like TV devices integrated with gesture recognition technology to allow users to download and experience various applications that may or may not be related to the content that they are viewing.

Various devices that support gesture recognition technology are coming up. Owing to a lack of standard for these devices, the applications that are written to be run on these various devices are device specific. In other words, gesture recognition dependent applications are not compatible across devices. For example, an application that can be run on a NINTENDO WII cannot be run on an XBOX. Similarly, an application that can be run on one TV set top box may not be run on another. However, such incompatibility is extremely inconvenient for an end user. For an end user enjoy all the applications that he likes, he must have all the devices that support the applications.

Therefore, there is a need for infrastructure that enables using applications across devices. That way, end users can run any application that they like on any gesture recognition capable device.

### BRIEF DESCRIPTION OF THE FIGURES

The embodiments herein will be better understood from the following detailed description with reference to the drawings, in which:

FIG. 1 illustrates the process of a user 101 controlling a user device 102 through gesture inputs;

FIG. 2 illustrates a user device 102 according to conventional systems that allow gesture recognition capable applications to be run;

FIG. 3 illustrates a user device 102 in a system that supports device independent gesture recognition based applications, according to an embodiment herein;

FIG. 4 illustrates the interaction between applications, GRIND middleware, and various sensor devices in accordance with an embodiment herein;

FIG. 5 illustrates a network of application developers and advertisers enabled by GRIND network to deliver applications to user through user devices, according to an embodiment herein;

FIG. 6 illustrates a gesture recognition capable user device 102 (for example, TV with required sensor devices), according to an embodiment herein;

FIG. 7 is a flow diagram of the method for developer's interaction with the network, according to an embodiment herein;

FIG. 8 is a flow diagram of the method for user's interaction with the network, according to an embodiment herein; and

FIG. 9 is a flow diagram illustrating the method for delivering advertisements to the user, according to an embodiment herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

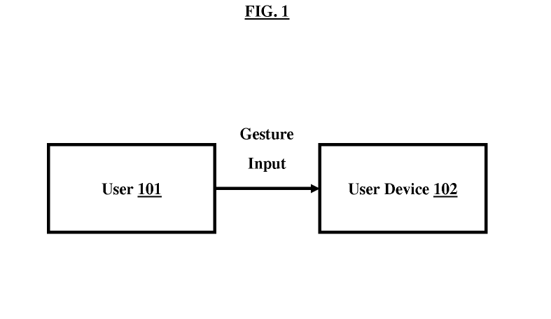

The embodiments herein disclose methods and systems of providing gesture recognition capable applications and advertisements for multiple devices through a single SDK. Preferably, the embodiments herein are enabled by Gesture Recognition Infrastructure for Networks and Devices (GRIND). Referring now to the drawings, and more particularly to FIGS. 1 through 8, where similar reference characters denote corresponding features consistently throughout the figures, there are shown embodiments.

FIG. 1 illustrates the process of a user 101 controlling a user device 102 through gesture inputs. The gesture inputs could be gestures using body parts like hands, heads and so on. Gesture inputs could be inputs using controllers, both wired and wireless, that ultimately send the required signal to the user device for the user device to understand the gesture.

The user device 102 may be a gesture recognition capable device like a Television, or a game console that supports gesture recognition using one or more sensor devices. The underlying capabilities of such user devices may vary depending on the device and its one or more sensing devices. Some examples of sensing devices include but are not limited to infra red devices, RGB cameras, scene analyzers, user trackers, hand point trackers, and gesture trackers. The underlying capabilities also determine the richness of the gesture recognition functionality that may be provided to the end user. Broadly, gesture recognition may be achieved through image recognition or video recognition. For image recognition based gesture recognition, devices may use a single camera to obtain gesture information. However, devices with depth aware cameras enable 3d gesture recognition like hand gestures. In some other devices, 3d representations may be approximated by the use of “stereo” cameras. Some devices may support controller based gestures.

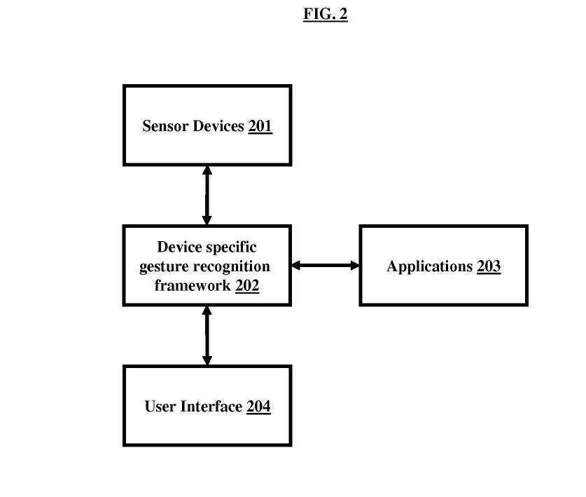

FIG. 2 illustrates a user device 102 according to conventional systems that allow gesture recognition capable applications to be run. In conventional systems that support gesture recognition based applications to interact with the various sensor devices that may be part of the device 102, the way an application interacts with the device is unique to the device. For example, if an application needs to check for capabilities of the various sensor devices to enable or disable certain functionality, the application needs to request for such information in a manner specific to the device. The same application may not be used in another device. Therefore, applications must be written specific to the device and its capabilities. For example, in conventional systems, a device specific API 202 may be provided to interact with the various sensor devices 201 for an application 203 to work with. Based on the capabilities and input from the user an application receives, the application interacts with the user through a user interface 204. The nature of the user interface 204 itself varies from one device to another, and from one application to another. User interface 204 could be a display device, a mechanical interface, an audio output and so on.

The device specific gesture recognition framework 202 may capture gesture movement of user and decide the action to be performed corresponding to the captured gesture. It may communicate with various sensor devices 201 in hardware layer and applications 203; and deliver the intended application to the user via a user interface 204 like a display (example, TV monitor). The system may have in its memory, a predefined set of gestures and corresponding actions to be performed. When a user performs a particular gesture, the gesture may be captured by a gesture recognition sensor device. The information is captured by the system specific gesture recognition framework. The framework may then check with the predefined database in the memory in order to identify the action to be performed corresponding to the captured gesture. The identified information may be forwarded to an application being used by the user of the user device 102. The application then may take appropriate action based on user gesture identified.

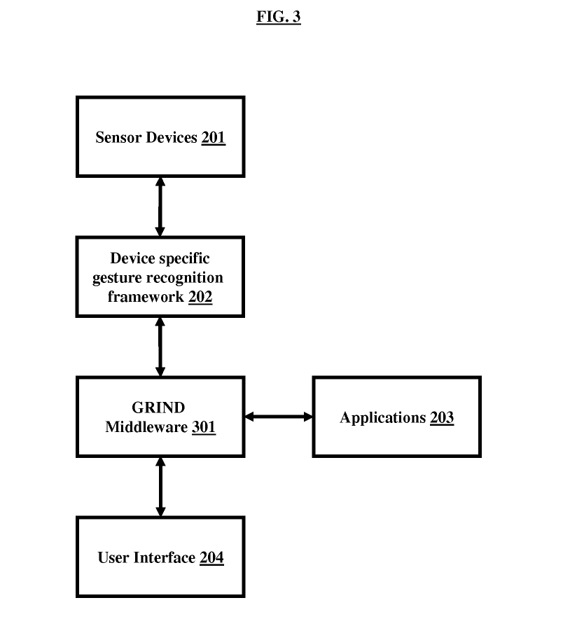

FIG. 3 illustrates a user device 102 in a system that supports device independent gesture recognition based applications, according to an embodiment herein. In this system, an application 203 interacts with a GRIND middleware 301 that in turn enables communication between the application 203 and the various sensor devices 201. In a preferred embodiment, the GRIND middleware 301 is specific to the device 102 and enables an application to communicate with and perform gesture recognition functions as long as the application is compatible with GRIND.

The device specific gesture recognition framework 102 captures gesture movements of user from one or more of the sensor devices 201. The GRIND middleware 301 in turn captures gesture information either directly from one or more of the sensor devices 201 and the device specific gesture recognition framework 202. The GRIND middleware 301 may then provide the gesture information and information relating to capabilities of one or more of the sensor devices 201 to the application 203 to take appropriate action based on the gesture information and capabilities available with the user device 102 through the various sensor devices 201.

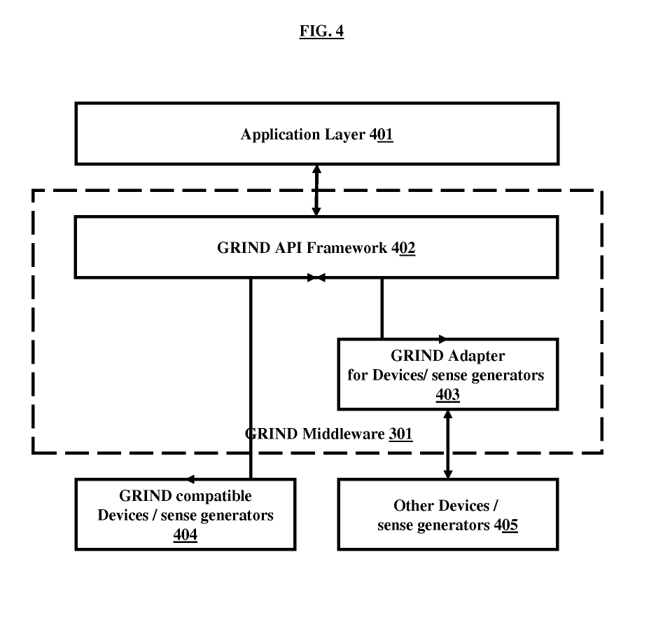

The GRIND middleware 301 acts as a middleware and enables communication between the application 203 and the sensor devices 201 with or without device specific gesture recognition frameworks 202. The way GRIND middleware 301 talks to the sensors 201 and the device specific frameworks 202 is specific to the user device 102, and hence will be different for different devices whereas the way an application talks to the GRIND middleware 301 will always be the same for all devices. Therefore, while the actual gesture recognition capabilities of a user device 102 may vary, an application that works on one GRIND enabled device will work on any other GRIND enabled device. Thus, the GRIND middleware 301 overcomes the compatibility issue of an application across various devices. FIG. 4 illustrates the interaction between applications, GRIND middleware, and various sensor devices in accordance with an embodiment herein. GRIND middleware allows for interaction between applications 203 in the application layer 401 of a user device 102 and various sensor devices 404, 405. Sensor devices 404, 405 that are part of a device may be already GRIND compatible 404. A sensor device is GRIND compatible if the sensor device understands method or procedure calls made by GRIND middleware without any mediation. However, some or all sensor devices part of a device may not be GRIND compatible and may be compatible with some other proprietary framework. GRIND middleware allows for interaction with sensor devices irrespective of the compatibility. If sensor devices 404 are compatible with GRIND already, GRIND middleware directly connects with such devices. If sensor devices 405 are not compatible with GRIND framework, then GRIND middleware may use one or more adapters 403 specific to corresponding one or more sensor devices that are part of the user device.

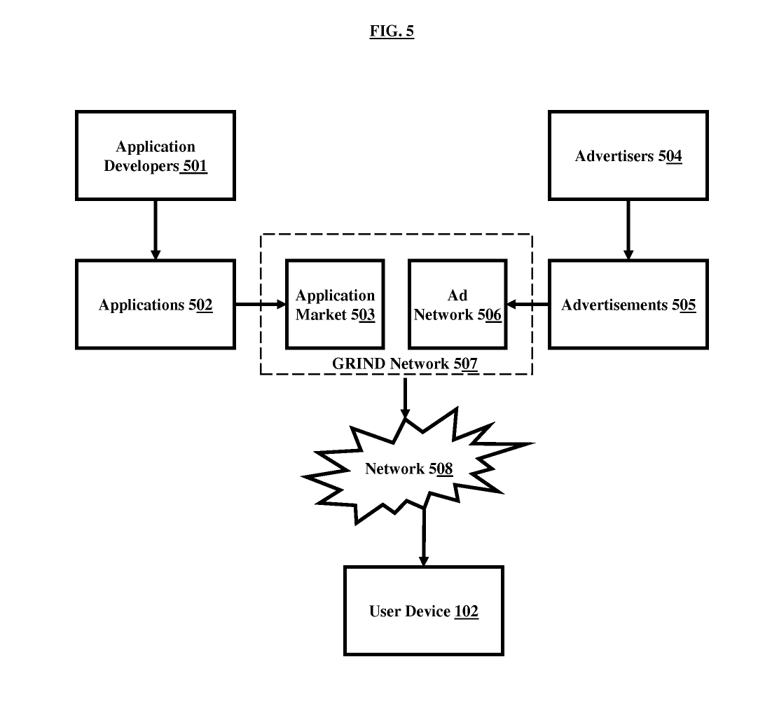

Some examples of sensor devices include but are not limited to infra red devices, RGB cameras, scene analyzers, user trackers, hand point trackers, and gesture trackers. In some embodiments, GRIND middleware 301 may use one adapter 403 for a set of sensor devices available in a user device 102. In some other embodiments, GRIND middleware 301 may use more than one adapter 403 for a set of sensor devices 201 available in a user device 102. In a preferred embodiments, GRIND middleware 301 may use one adapter 403 per sensor device 201 available in a user device 102. FIG. 5 illustrates a network of application developers and advertisers enabled by GRIND network to deliver applications to user through user devices, according to an embodiment herein. The network comprises of application developers 501, advertisers (or advertising units of media enterprises) 504. The application developers 501 develop applications 502 and the advertisers (or advertising units) develop advertisements 505. GRIND network 507 allows for publishing and management of applications 502 and advertisements 505 produced by the developers 501 and advertisers 504. In a preferred embodiment, the GRIND network 507 may comprise of an application market 503 to enable an application market place for application developers 501 to publish their applications 502. In a preferred embodiment, the GRIND network 507 may further comprise of an Ad Network 506 that enables a channel for publishing advertisements 505 to target audience. The applications 502 and advertisements 505 published through the GRIND network 307 are delivered to user devices 102 through a network 508. The network 508 could be a suitable network for communication such a Internet, Cable network, and Satellite communication network among others.

Users accessing content such as applications 502 and advertisements 505 through user devices 102 develop a history of using such content. In some embodiments, the GRIND network 507 may obtain such user history, based on user permission settings, to analyze various parameters including but not limited to user content preferences, and user profile information. Such analysis may be used in providing targeted advertisements. In some embodiments, the user activity information may be sent by applications on a periodic basis. Such activity information may be used to understand and analyze the kind of gestures and applications a particular user prefers. Such analysis may be used to deliver content (both applications 502 and advertisements 505) that users may actually interact with. Through the ad network (506), GRIND network 507 enables creation of an ad unit that allows for delivering gesture recognition based rich media advertisements during the course of running an application 502. In some embodiments, the advertisements 505 may be delivered to a user through the request of an application 502 being run by the user. In some embodiments, the advertisements 505 requested by the application 502 may be based on advertisement profile preferences provided by user, where user may add preferences specific to the nature of advertisements 505 based on parameters including but not limited to domain, level of interactivity, location of services, user previous history in terms of level of interactivity with advertisements, and target demographic audience of an advertisement. In some other embodiments, the advertisements may be fetched by applications directly based on user's history of using applications, and the user's level of interactivity with advertisements among others, with or without checking for user profile information. The gesture recognition capable advertisements may run like any other application. However, advertisements may be invoked by another application.

In various embodiments, the advertisements may be delivered while an application is in progress, where the application may check for advertisements on a periodic or random basis. In some embodiments, advertisements may be delivered when the user's device is idle. In some other embodiments, advertisements may be delivered to the user at the time of starting an application or ending an application.

In various embodiments, the advertisements delivered need not be gesture recognition capable. They may be standard audio/visual media advertisements or text media based advertisements that are capable of being rendered by the device being used by a user.

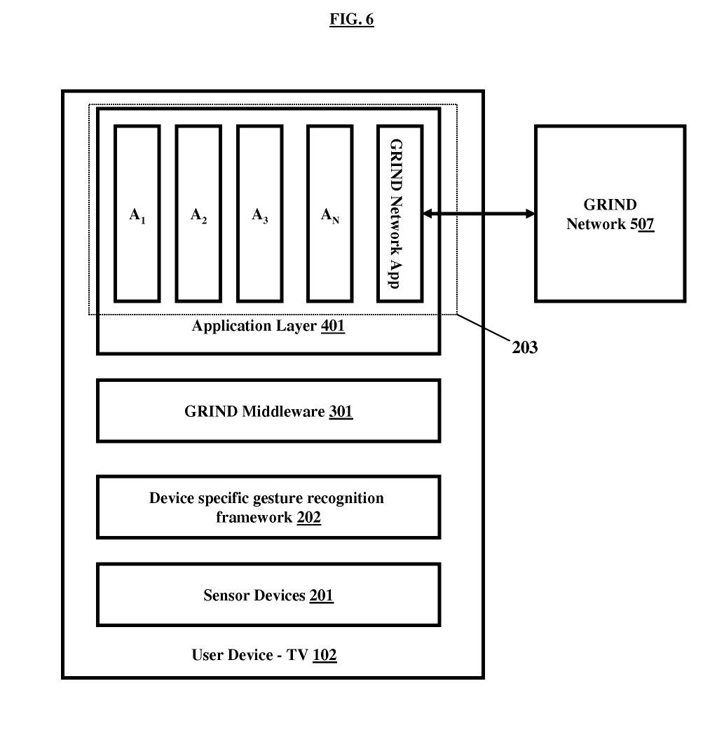

FIG. 6 illustrates a gesture recognition capable user device 102 (for example, TV with required sensor devices), according to an embodiment herein. In an embodiment, the user device 102 may comprise of a plurality of sensor devices 201, a device specific gesture recognition framework 202 to interact with one or more of sensor devices 201, GRIND middleware to interact with one or more sensor devices 201 and the device specific gesture recognition framework 202. The user device also comprises of an application layer 401 comprising one or more applications 203 on the user device.

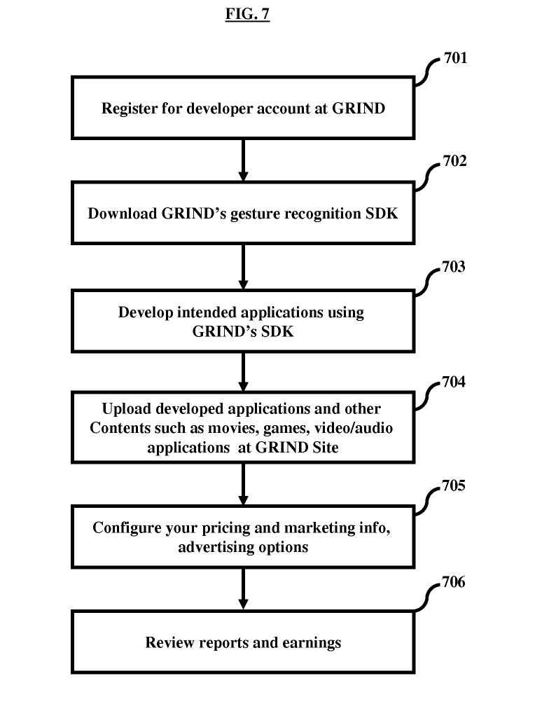

In a preferred embodiment, one of the applications 203 on the user device 102 is a GRIND network app 203 that allows for delivering content to the user device 102 and capturing information from the user device 102 to transmit to the GRIND network 507. The GRIND network app 203 may also be used by users of the user device 102 to search for content, configure preferences for content (both applications and advertisements) to be delivered to their user device 102. FIG. 7 is a flow diagram of the method for developer's interaction with the network, according to the embodiments disclosed herein. The application developer 501 registers (701) for a developer account in the GRIND website. Once the registration (701) is done, the developer 501 downloads (702) the GRIND's gesture recognition SDK using which he can develop (703) the intended applications. Then the developed applications and other contents such as movies, audio/video files, games etc are uploaded (704) to application market 503 on the GRIND network 507. Then the application developer 501 configures (705) pricing, marketing info and advertisements information along with any preferences on the application market 503. In some embodiments, the developers 501 may be able to review (706) reports and earnings from their applications. One example of a report is a usage report based on parameters like location, and demography among other parameters.

The various actions in method 700 may be performed in the order presented, in a different order or simultaneously. Further, in some embodiments, some actions listed in FIG. 7 may be omitted.

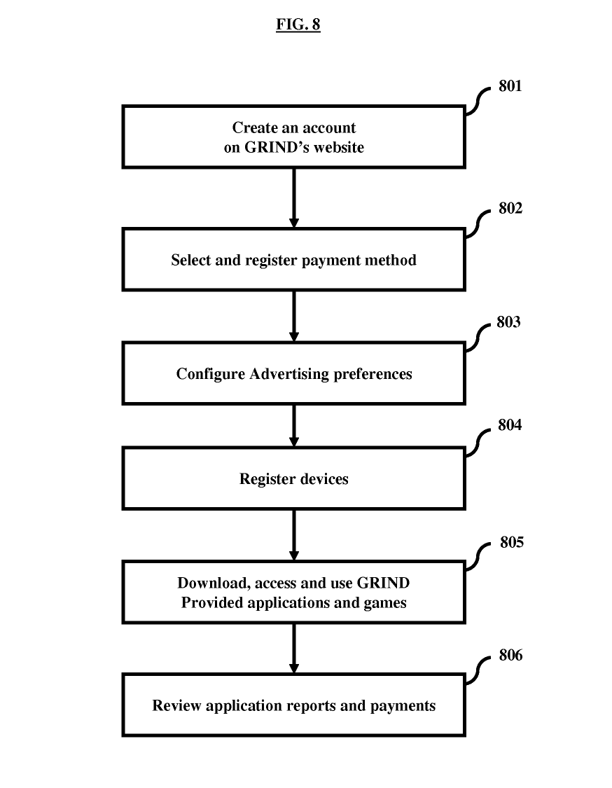

FIG. 8 is a flow diagram of the method for user's interaction with the network, according to the embodiments disclosed herein. The user creates (801) an account on GRIND's network 507. While registering (801) for the service, user may select and register (702) a payment method. Then the user may configure (803) advertising preferences and thus register (804) for services. Then the user may download, access and use (805) the requested content from the GRIND network. In some embodiments, the user may be able to review (806) various reports and billing summary through the GRIND network app 203.

The various actions in method 800 may be performed in the order presented, in a different order or simultaneously. Further, in some embodiments, some actions listed in FIG. 8 may be omitted.

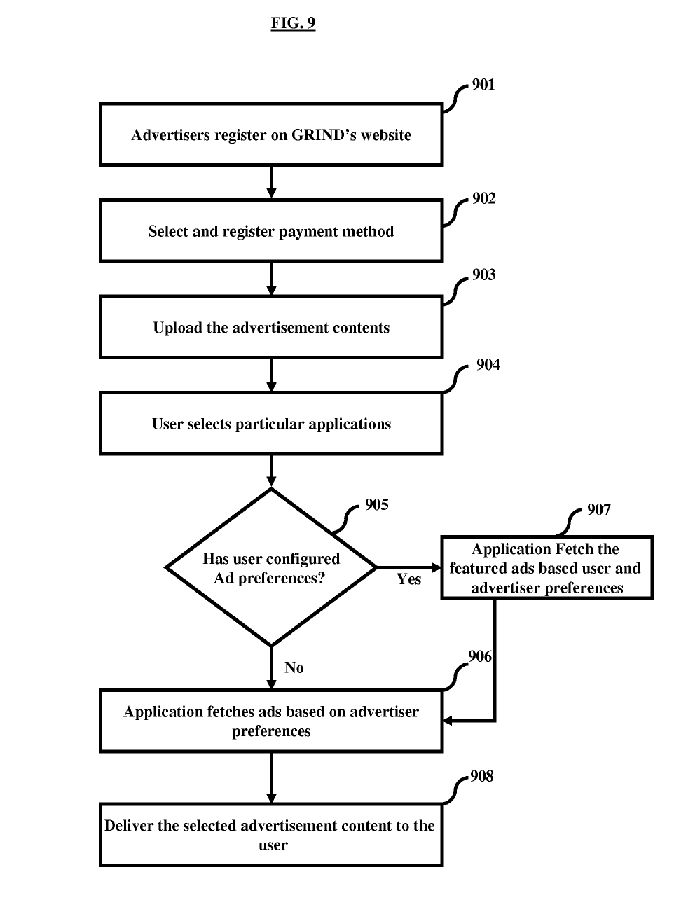

FIG. 9 is a flow diagram illustrating the method for delivering advertisements to the user, according to embodiments disclosed herein. The advertisers 504 register (901) on GRIND's network. The advertiser 504 may select and register (902) a payment method. Once the account is created, the advertisement contents 505 are uploaded (903) into the network 507 (ad network 506). When the user selects and runs (904) particular applications 203 on the user device 102, a check (905) is made if the user has configured advertisement preferences. If user has specific advertisement preferences configured, the application 203 fetches (907) the featured ads 505 and delivers (908) to the user according to the preferences of advertisers 504 and users. If there are no user specific advertisement preference configured, the application fetches (906) the advertisements 505 according to advertiser 504 preferences and delivers (908) them to the user.

In some embodiments, fixed advertisements 505 may be associated with an application 203 on the user device 102 and those advertisements 505 may be downloaded as part of the application. In some other embodiments, the fixed advertisements 505 associated with an application 203 on the user device 102 may be downloaded from the ad network 506 as and when required by the application 203.

The various actions in method 900 may be performed in the order presented, in a different order or simultaneously. Further, in some embodiments, some actions listed in FIG. 9 may be omitted.

The embodiments disclosed herein can be implemented through at least one software program running on at least one hardware device and performing network management functions to control the network elements. The network elements shown in FIG. 1 to FIG. 6 include blocks which can be at least one of a hardware device, or a combination of hardware device and software module.

The embodiments disclosed herein provide for methods and systems for supporting gesture recognition applications across devices. Therefore, it is understood that the scope of the protection is extended to such a program and in addition to a computer readable means having a message therein, such computer readable storage means contain program code means for implementation of one or more steps of the methods, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method of supporting a gesture recognition capable application across plurality of gesture recognition capable devices, said method comprising providing a gesture recognition middleware specific to a gesture recognition capable device from said plurality of gesture recognition capable devices, wherein said gesture recognition middleware exposes a same API for said gesture recognition capable application irrespective of gesture recognition capabilities of said gesture recognition device for which said gesture recognition middleware is provided.

2. A method of enabling developers to write a gesture recognition capable application compatible with plurality of gesture recognition capable devices, said method comprising
providing a gesture recognition middleware specific to a gesture recognition capable device from said plurality of gesture recognition capable devices;
providing a software development kit to write applications compatible with said middleware,
wherein said gesture recognition middleware exposes a same API for said gesture recognition capable application irrespective of the device for which said gesture recognition middleware is provided.

3. A gesture recognition apparatus comprising a gesture recognition middleware for supporting a gesture recognition capable application operable on a gesture recognition capable device, said middleware comprising at least one means for connecting to plurality of sensor devices of said device using a device independent API framework; and
enabling communication between said gesture recognition application and said plurality of sensor devices to provide gesture recognition capabilities to said application,
wherein said gesture recognition middleware exposes a same API for said gesture recognition capable application irrespective of said plurality of sensor devices of said gesture recognition capable device.

4. The apparatus as in claim 3, wherein said plurality of sensor devices comprise of one or more of devices from infra red device, RGB camera, scene analyzer, user tracker, hand point tracker, and gesture tracker.

5. A gesture recognition apparatus comprising a gesture recognition middleware for supporting a gesture recognition capable application operable on a gesture recognition capable device, said middleware comprising at least one means for connecting to plurality of sensor devices of said device using a device specific API framework through one or more adapters; and
enabling communication between said gesture recognition application and said plurality of sensor devices to provide gesture recognition capabilities to said application,
wherein said gesture recognition middleware exposes a same API for said gesture recognition capable application irrespective of plurality of said sensor devices of said gesture recognition capable device.

6. The apparatus as in claim 4, wherein said plurality of sensor devices comprise of one or more of devices from infra red device, RGB camera, scene analyzer, user tracker, hand point tracker, and gesture tracker.

7. A method of enabling communication between a device independent gesture recognition framework and a sensor device comprises providing a device specific adapter between said device independent gesture recognition framework and said sensor device.

8. The method as in claim 7, wherein said sensor device is one among a set of sensor devices comprising infra red device, RGB camera, scene analyzer, user tracker, hand point tracker, and gesture tracker.
